(19) United States
(12) Patent Application Publication
(10) Pub. No.: US 2002/0046153 A1
(43) Pub. Date: Apr. 18, 2002

(54) Remote method and system for facilitating commercial transactions

(76) Inventor: Nancy Piggins, Macomb, MI (US)

Correspondence Address: Scott A. Chapple, Dobrusin & Thennisch PC, Suite 311, 401 South Old Woodward Avenue, Birmingham, MI, 48009, US

(21) Appl. No.: 09/911,984

(22) Filed: Jul. 24, 2001

Related U.S. Application Data
(60) Provisional application No. 60/220,289, filed on Jul. 24, 2000.

(51) Int. Cl. G06F 17/60

(52) U.S. Cl. 705/37

(57) ABSTRACT

According to the present invention, there is disclosed a business methodology that aids communications between commercial merchants and consumers. According to the methodology, data related to consumers can be entered into a computer database that includes preprogrammed communication links to a wireless data network such that the network can be searched for retrievable customer specific communication links. Thereafter, data communication between the database and the customer specific data communications link is facilitated such that interactive data may be transmitted to a customer operated wireless communications device.

### FIELD OF THE INVENTION—Retail Direct Messaging (RDM)

The present invention relates generally to a method of doing business that allows retailers and commercial establishments to communicate with consumers and store customers utilizing computers, computerized cash registers, smart appliances, wireless service, and wireless phones. More particularly, the present invention discloses a method for facilitating commercial transactions providing an in store display capable of being utilized by retailers or consumers through data input. The in store display allows retailers or consumers to tell the computer what they would like to know, e.g., date of in store promotion, service reminder, date of item availability, etc. and the computer will automatically send a text message to the customer's wireless phone, or other chosen communications device, as soon as the information becomes available.

### BACKGROUND OF INVENTION

Communication between stores and consumers is essential in the retail sales industry. Stores need to provide consumers with up to date information regarding in-store promotions, availability of items, and delivery dates of orders already placed, among other things.

Typically, retailers communicate with consumers and customers through mass mailings, or utilize computerized data and database marketing to target customers and communicate with them through the mail or in a more personal manner (e.g., telephone calls). These methods have several disadvantages for both the retailers and customers. For example, the mail system is often slow, impersonal and cluttered and a faster, more personalized and effective system would benefit both retailers and customers. Some systems and methodologies exist in the prior art for facilitating communications between retailers or merchants. For example, U.S. Pat. No. 6,167,255 is directed to a System And Method For Providing Menus Data Using A Communication Network and is hereby expressly incorporated by reference.

The present invention, however, provides a more intelligent, high tech method of communicating with consumers and has several advantages over the prior art. The present invention not only expands and personalizes the retailer's communications with consumers, it allows for faster, more effective communications that better fit today's busy lifestyles. In addition, messages sent through the present invention can also be consumer-specific by utilizing a customer database which collects and records personalized customer information. Rather than sending a mass mailing, retailers using the present invention can select the specific promotional information to be sent to a customer based on past purchases or stated preferences. The present invention also allows customers to choose what information they would like sent to them, ensuring that all communications will be appreciated by the customer, thus building a better retailer/customer relationship as well as adding value to the relationship and creating potential marketing data.

### SUMMARY OF THE INVENTION

According to one aspect of the invention, there is disclosed a method of doing business that aids in communications between commercial merchants and consumers comprising the steps of: 1) entering customer specific data inquiries into a computer database, the database having preprogrammed communication links to a wireless data network; 2) searching the wireless data network for customer specific communication links; 3) retrieving the customer specific data communication link; 4) facilitating interactive data communication between the database and the customer specific data communications link; and 5) transmitting interactive data to customer operated wireless communications device.

According to another aspect of the present invention there is disclose a method for receiving and transmitting consumer inquiries for commercial items to a pre-selected location for placement. The method includes the steps of: 1) providing a computer for transmitting signals to and receiving signals from customer operated devices, wherein the computer receives customer purchase inquiry information; 2) comparing customer identifier with customer profile information stored on a computer readable medium associated with the computer; 3) retrieving an existing customer profile or creating a new customer profile if no existing file is available; 4) transmitting a signal representative of a visual display of purchase inquiry items; and 5) transmitting customer inquiry data to an operation center for placement.

### BRIEF DESCRIPTION OF THE DRAWINGS

These and other objects, features, aspects and advantages of the invention will become apparent upon consideration of the specification and appended drawing in which:

FIG. 1 is a flow diagram of an example of a remote method and system for facilitating commercial transactions according to one aspect of the present invention.

### DETAILED DESCRIPTION OF THE INVENTION

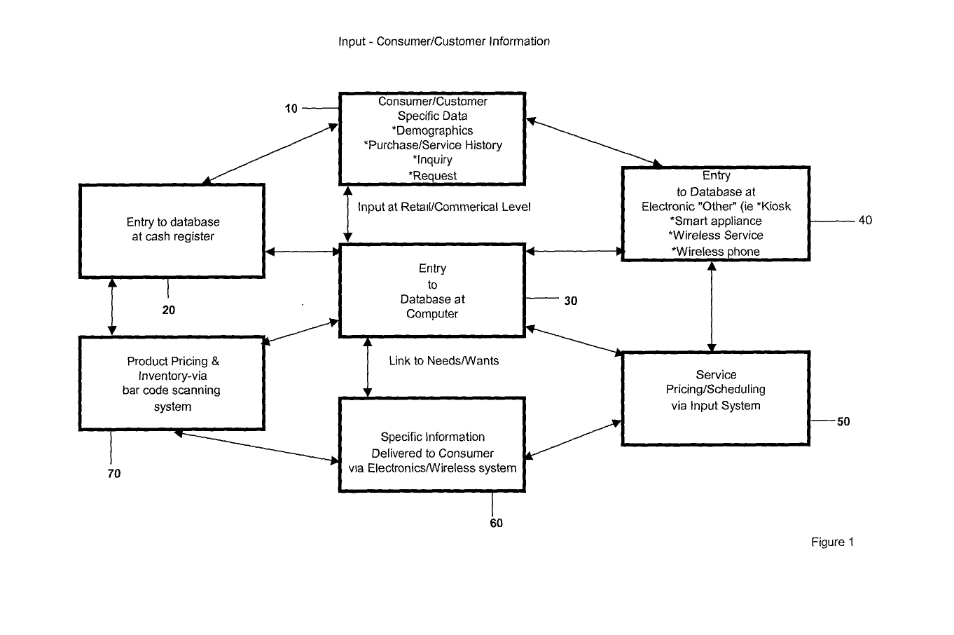

As depicted in FIG. 1, the present invention surpasses the prior art by utilizing existing computers, computerized cash registers, smart appliances, wireless service, and wireless phones for facilitating communications between consumers and retailers. Message delivery is automatic and nearly instantaneous through the use of computer-sent text messages to wireless phones (or e-mail devices). The present invention works regardless of where the customer bought his wireless phone (i.e., the customer does not have to own a phone purchased from the retailer). Moreover, the present invention can operate in a variety of capacities for a variety of retailing purposes.

For example, a customer, who owns a wireless phone, enters a retail store wanting or needing a new lawnmower, new furniture, and a new suit. The customer may typically order the selected item in the store and be given a delivery date. Alternatively, the customer may order the selected item through the store catalog and also be given a delivery date and time. In still another alternative, the customer may decide that the item is too expensive to purchase at the time. The present invention can be utilized for each of these hypothetical transactions and/or situations.

First, the salesperson can attain customer specific data as indicated at block 10. For example, the salesperson can ask whether the customer would like to be notified when the lawnmower goes on sale, saving the sale for the retailer and allowing the customer to purchase the lawnmower at a price he can afford. When the customer indicates that he would like this service, the salesperson need only enter the customer's name and wireless phone number into the computer database, along with the stock/item number for the lawnmower he wishes to purchase. The salesperson could enter the information at, for example, a cash register as indicated at block 20 or a computer as indicated at block 30. Alternatively, the customer or salesperson could enter the information at another remote location from the database such as a KIOSK, smart applicance, wireless service, wireless phone or the like, as indicated at block 40. When the lawnmower goes on sale, the item number, at the new price for bar code scanning, is entered into the computer using an input system as indicated at block 50. The computer, using the present invention's program will automatically cross reference any and all customers waiting for the product to go on sale. The computer then sends a preprogrammed text message to the customer's wireless cell phone to notify the customer of the sale as indicated at block 60. The customer may then go to the store or call the store to hold the item, which would hold the item in inventory using barcode scanning as indicated at block 70. The message can give the customer these choices along with a single preprogrammed phone button that could allow the customer to contact the retailer instantly.

Second, the present invention can alert the customer of delivery of an ordered item. When the above furniture order is placed, the order and the customer's wireless phone number are both entered into the computer (block 10). When the furniture arrives at the retailer's shipping dock, its bar code number (using the present invention's program) is scanned in (block 70) and the database automatically cross-references the name and the number of the customer waiting for the delivery (block 30). The computer, again using the present invention's software, immediately sends a Retail Direct Message (RDM) to the customer's wireless phone (block 60), notifying him that the furniture has arrived and of the scheduled delivery date. Through the present invention, the customer is kept up to date on the status of his delivery and may call the retailer to change the date or time, or for further verification.

The present invention also works for catalog orders. The customer's wireless telephone number, along with the suit order, is entered into the computer when the order is placed (block 10). The computer is preprogrammed to automatically send a Retail Direct Message to the customer's wireless number when his suit arrives (blocks 30, 60, 70). Additionally, the message can be programmed to deliver any other relevant information: i.e., how long it will be held for pick-up, choice of having it shipped directly to the customer's home or business, total amount due, etc. The range of programmable messages is practically unlimited.

As further seen in FIG. 1, the present invention is not limited to direct customer orders or inquires. The present invention can work through an existing database, for example—a comprehensive database consisting of the retailer's charge customers, to further enhance communication. The present invention can utilize any key marketing information that has already been gathered and stored electronically and enter the information as customer specific data (block 10). Thereafter, customers may be contacted directly (block 60), providing them the specific information they need or want. For example, the present invention can know and respond automatically to customers' birthdays, or other stored information such as overdue balances or available credit. Furthermore, the present invention allows for the updating of the databases. Virtually any type of information may be added into the database at any time and utilized by the present invention. Updates can be accomplished through a phone call to the retailer, e-mail, in-store contact with a salesperson, or by a sign-up request form offering RDM Notification Choice. The present invention will automatically send a Retail Direct Message to the customer (block 60) as long as the retailer inputs the request and the appropriate code number (block 10) into the computer (block 30).

Data communication between the customer and the commercial establishment is conducted using software and/or hardware that are well known in the art, such as software interface, wide area networks, and interactive cable television systems.

The present invention offers a further option for customers who purchase their wireless communication devices from the retailer. Consumers may choose any personalized notifications they would like to receive at the time of purchase, and of course, updates will still be available as outlined above.

The present invention is not confined to the use of retailers' cash register units. The present invention also encompasses in store display units (e.g., a KIOSK as indicated at block 40) that customers may utilize on their own or with the aid of a salesperson. For example, a customer needs a new lawnmower, but the model he wants is not in stock. The customer can enter the item number into the in store display unit along with his wireless phone number and a request to be notified when the item is in stock. The computer will automatically send a text message to the customer's wireless phone when the item number is scanned into the computer system upon delivery to the store.

The present invention thus is a method of doing business, which allows for more effective communications from a retailer to a consumer. Using existing technology, the present invention allows retailers to send text messages to customers' wireless phones. These messages can take on a nearly infinite variety of forms for numerous retailer demands.

The present methodology is also contemplated as covering a method for receiving and transmitting consumer inquiries for commercial items to a pre-selected location for placement. Using this embodiment of the present invention, a computer receives customer purchase inquiry information by transmitting signals to and receiving signals from customer-operated devices. The computer then compares customer identifier with customer profile information stored on a computer readable medium associated with the computer and retrieves the existing customer profile. If no profile exists, the computer will create a new customer profile. The computer transmits a signal representative or a visual display of purchase inquiry items along with customer inquiry data to an operation center for placement.

Although the present invention has been described with reference to specific examples, numerous modifications and variations can be made and the result will still come within the scope of the invention as further elaborated in the following claims. No limitation with respect to the specific examples disclosed herein is intended to be inferred.

What is claimed is:

1. A method of doing business aiding in communications between commercial merchants and consumers comprising the steps of:
(a) entering customer specific data inquiries into a computer database, said database having preprogrammed communication links to a wireless data network;
(b) searching said wireless data network for customer specific communication links;
(c) retrieving said customer specific data communication link;
(d) facilitating interactive data communication between said database and said customer specific data communications link;
(e) transmitting interactive data to customer operated wireless communications device.

2. A method for receiving and transmitting consumer inquiries for commercial items to a pre-selected location for placement, comprising:
providing a computer for transmitting signals to and receiving signals from customer operated devices, wherein the computer receives customer purchase inquiry information;
comparing customer identifier with customer profile information stored on a computer readable medium associated with the computer;
retrieving an existing customer profile or creating a new customer profile if no existing file is available;
transmitting a signal representative of a visual display of purchase inquiry items; and
transmitting customer inquiry data to an operation center for placement.

3. The method for receiving and transmitting consumer inquiries for commercial items as defined in claim 2, wherein the computer is associated with a server for permitting data communication between the computer and one or more customer operated devices.

4. The method for receiving and transmitting consumer inquiries for commercial items as defined in claim 2, wherein the computer readable medium is programmed with software instructions for retrieving an existing customer profile or creating a customer profile.

5. The method for receiving and transmitting consumer inquiries for commercial items as defined in claim 4, wherein the customer profile information is stored on the computer readable medium.

6. The method for receiving and transmitting consumer inquiries for commercial items as defined in claim 2, wherein the computer readable medium is a random access memory, read only memory, floppy disk, magnetic hard disk drive, a magnetic/digital tape or a CD-ROM.

7. The method for receiving and transmitting consumer inquiries for commercial items as defined in claim 2, wherein the customer operated devices include a computer, personal data assistants, telephones, pagers, television systems, or a household appliance.

8. The method for receiving and transmitting consumer inquiries for commercial items as defined in claim 2, wherein the visual display includes graphic representations of retail items.

9. The method for receiving and transmitting consumer inquiries for commercial items as defined in claim 2, wherein the visual display includes alphanumeric representations of retail items.

10. The method for receiving and transmitting consumer inquiries for commercial items as defined in claim 2, wherein the signals representative of a visual display of retail items.

11. The method for receiving and transmitting consumer inquiries for commercial items as defined in claim 2, wherein the method further includes the step of transmitting a signal confirming the customer's inquiry information.

12. The method for receiving and transmitting consumer inquiries for commercial items as defined in claim 2, wherein the method further includes the step of prompting the customer to place the selected items by choosing among displayed payment options.

13. The method for receiving and transmitting consumer inquiries for commercial items as defined in claim 12, wherein the displayed payment options include cash at time of placement, credit card, money order, or debit card.

14. The method for receiving and transmitting consumer inquiries for commercial items as defined in claim 2, wherein the computer activates a search algorithm that cross-references customer profile data with geographic information stored on the computer readable medium for each operation center.

15. The method for receiving and transmitting consumer inquiries for commercial items defined in claim 1, wherein the computer activates a bar code associated with the selected item.

16. The method for receiving and transmitting consumer inquiries for commercial items defined in claim 2, wherein the computer activates a bar code associated with the selected item.
